(19) United States
(12) Patent Application Publication
(10) Pub. No.: US 2017/0009886 A1
(43) Pub. Date: Jan. 12, 2017

(54) BEARING INTERFACE WITH RECESSES TO REDUCE FRICTION

(71) Applicant: Ford Global Technologies, LLC, Dearborn, MI (US)

(72) Inventors: Ian Graham Pegg, Chelmsford (GB); Sorin-Cristian Vladescu, London (GB); Andrew Vernon Olver, Reading (GB); Thomas Reddyhoff, London (GB)

(21) Appl. No.: 15/195,796

(22) Filed: Jun. 28, 2016

(30) Foreign Application Priority Data
Jul. 10, 2015 (GB) 1512115.5

(51) Int. Cl. F16J 9/12

(52) U.S. Cl. CPC F16J 9/12

(57) ABSTRACT

A bearing interface of an apparatus, the apparatus having a first element and a second element configured to move relative to each other during operation of the apparatus, the first element comprising a first bearing surface configured to engage at least a portion of a second bearing surface of the second element thereby defining a contact zone between the first bearing surface and the second bearing surface, the first bearing surface having at least one recess indented into the first bearing surface, wherein the dimension of the recess in the direction of movement of the second element relative to the first element is less than the dimension of the contact zone in the direction of movement of the second element.

### CROSS REFERENCE TO RELATED APPLICATION

This application claims priority to Great Britain Patent Application No. 1512115.5, filed Jul. 10, 2015, the entire contents of which are hereby incorporated by reference for all purposes.

### FIELD

This disclosure relates to a bearing interface having a plurality of recesses indented into a bearing surface of the bearing interface, and in particular, but not exclusively, relates to a bearing interface in a machine, the machine having a plurality of recesses provided only in predetermined regions of the bearing surface of the bearing interface.

The machine may comprise a linear actuator or a rotary machine. The term “rotary machine” is intended to encompass reciprocating machines such as internal combustion engines, compressors and vacuum pumps, as well as machines with rotating components but no reciprocating parts.

### INTRODUCTION

An internal combustion engine typically has one or more reciprocating pistons which are lubricated to reduce the friction as the piston slides within a cylinder bore. Lubricated sliding contacts, such as between the piston rings of a piston and an inner surface of the cylinder bore, have frictional losses due to the shear forces generated in the lubricant, contact between surface asperities, and boundary contacts caused by additives in the lubricant.

It is desirable to reduce the friction between the piston rings and the inner surface of the cylinder in order to increase the efficiency of the engine and reduce wear between engine components. The friction between the components may be determined by a number of factors, which include the operational parameters of the engine and the configuration of each of the sliding surfaces. For example, the frictional coefficient between sliding components may be determined using the Stribeck curve, which is used to categorize the frictional properties between two surfaces as a function of the viscosity of the lubricant and the relative speed between the components per unit load. As such, friction may be minimized by operating at the minimum point on the Stribeck curve, which defines the transition between hydrodynamic lubrication and mixed lubrication. However, it is difficult to maintain operation at the minimum point on the Stribeck curve across the full piston stroke as a result of the low relative speed between the piston and the cylinder at the extremes of the range of movement of the piston.

### SUMMARY

According to an aspect of the present disclosure there is provided a bearing interface of an apparatus, for example a machine such as an engine, a compressor, a vacuum pump or a gear box. The apparatus may comprise any type of machine having the bearing interface. The apparatus has a first element and a second element. The first element may be configured to move, for example slide and/or rotate, relative to the second element during operation of the apparatus. The second element may be configured to move, for example slide and/or rotate, relative to the first element during operation of the apparatus. The first element may be fixed, for example stationary, relative to the second element during operation of the apparatus. The second element may be fixed, for example stationary, relative to the first element during operation of the apparatus. The first element comprises a first bearing surface. The second element comprises a second bearing surface. The first and second bearing surfaces are configured to engage each other. The term ‘engage’ is intended to encompass two surfaces which are separated by a thin film of lubricant, as well as surfaces which come into direct physical contact. The first bearing surface is configured to engage at least a portion of a second bearing surface. The portion of the second element that engages the first element defines a contact zone between the first bearing surface and the second bearing surface. The first bearing surface has at least one recess, for example a pocket, indented into the first bearing surface. The recess may comprise an opening in the first bearing surface. The dimension of the recess, for example the dimension of the opening of the recess, in the direction of movement of the second element relative to the first element is less than the dimension of the contact zone in the direction of movement of the second element.

The first bearing surface and at least the portion of the second bearing surface may be parallel in the contact zone during operation of the apparatus. The second bearing surface may be configured to deform elastically upon engagement with the first bearing surface. The dimension of the contact zone in the direction of movement of the second element may be defined by the dimension of the elastically deformed portion of the second bearing surface in the direction of movement of the second element. The dimension of the recess in the direction of movement of the second element may be less than the dimension of the elastically deformed portion of the second bearing surface in the direction of movement of the second element.

A lubricant may be used to reduce the friction between the first and second bearing surfaces. A lubricant film may be provided, for example formed, in the contact zone between the first bearing surface and the second bearing surface during operation of the apparatus. The lubrication regime between the first and second bearing surfaces may be a hydrodynamic lubrication regime, a mixed lubrication regime and/or a boundary lubrication regime. The lubrication regime may transition between the hydrodynamic lubrication regime, the mixed lubrication regime and/or the boundary lubrication regime, depending on the operational parameters of the apparatus. The film of lubricant may have a film thickness that is substantially constant in the direction of movement of the second element during operation of the apparatus.

The dimension of the recess in the direction of movement of the second element may be less than the dimension of the film of lubricant in the direction of movement of the second element. The recesses may be configured to trap lubricant. The recesses may be configured to increase locally the thickness of the film of lubricant in the contact zone.

A reciprocating machine, such as an engine or compressor, may be provided having one or more of the bearing interfaces. The engine may comprise one or more cylinders and/or one or more engine pistons. The first element may be an engine cylinder. The first bearing surface may be an inner surface of the cylinder. The second element may be a piston ring of the engine piston. The second bearing surface may be a circumferential surface of the piston ring. A least a portion of the circumferential surface of the piston ring may be configured to engage the inner surface of the cylinder. Each cylinder may have an inner surface configured to engage at least a portion of a circumferential surface of a piston ring of an engine piston. The portion of the piston ring that engages the inner surface may define the contact zone between the inner surface of the cylinder and the circumferential surface of the piston ring. The contact zone may have a dimension in the direction of travel of the piston, for example an axial dimension that defines the overall length of the contact zone in the direction of travel of the piston. The inner surface may have at least one recess indented into the inner surface. The recess may have a dimension in the direction of travel of the piston, for example an axial dimension that defines the overall length of the recess in the direction of travel of the piston. The dimension of the recess in the direction of travel of the piston may be less than the dimension of the contact zone in the direction of travel of the piston.

The inner surface of the cylinder and at least a portion of the circumferential surface of a piston ring may be parallel in the contact zone, for example during operation of the engine. The piston ring and/or the inner surface may be configured to deform elastically under loading. The portion of the piston ring that deforms elastically under loading and engages the inner surface of the cylinder may define an elastic contact zone between the inner surface of the cylinder and the circumferential surface of the piston ring. The dimension of the contact zone in the direction of travel of the piston may be defined by the dimension, for example the axial length, of the elastically deformed portion of the piston ring. The circumferential surface of the piston ring and the inner surface of the cylinder may be parallel as a result of the elastic deformation of the piston ring and/or the inner surface. The dimension of the recess in the direction of travel of the piston may be less than the dimension of the elastically deformed portion of the piston ring in the direction of travel of the piston.

A lubricant may be used to reduce the friction between the piston ring and the inner surface of the cylinder. A lubricant film may be formed in the contact zone between the circumferential surface of the piston ring and the inner surface of the cylinder during operation of the engine. The lubricant film in between at least a portion of the circumferential surface and the inner surface may have a film thickness that is substantially constant in the direction of travel of the piston during operation of the engine. For example, the film thickness of the lubricant film may be substantially constant where the circumferential surface of the piston ring and the inner surface of the cylinder are parallel. The portion of the lubricant film that has a substantially constant film thickness may have a dimension in the direction of travel of the piston, for example an axial dimension that defines the overall length of the portion of the lubricant film that has a substantially constant film thickness. The dimension of the recess in the direction of travel of the piston may be less than the dimension of the portion of the lubricant film that has a substantially constant film thickness in the direction of travel of the piston.

The inner surface may comprise a top region having a plurality of recesses indented into the inner surface. The top region may extend towards the bottom end of the cylinder away from a contact zone between a top piston ring and the inner surface when the piston is at top dead center of a stroke. The inner surface may comprise a bottom region having a plurality of recesses indented into the inner surface. The bottom region may extend towards the top end of the cylinder away from a contact zone between a bottom piston ring and the inner surface when the piston is at bottom dead center of the stroke of the piston. The inner surface may be an inner surface of a bore of a cylinder block. The inner surface may be an inner surface of a cylinder liner.

The recesses may be configured to retain a fluid, for example each recess may comprise a pocket configured to trap the fluid in the inner surface. The recesses may be configured to slow down the rate at which fluid drains away from the top and/or bottom regions of the inner surface. The top region and the bottom region may be separated by a middle region having no recesses indented into the inner surface. The top region and the bottom region may be spaced apart, for example by the middle region, in the direction of travel of the piston.

The top region may comprise a top band of recesses extending around the full circumference of the inner surface. The bottom region may comprise a bottom band of recesses extending around the full circumference of the inner surface. The middle region may comprise a middle band having no recesses extending around the full circumference of the inner surface. The top band may have an axial dimension in the direction of travel of the piston. The bottom band may have an axial dimension in the direction of travel of the piston. The middle band may have an axial dimension in the direction of travel of the piston. The axial dimension of the middle band may be greater than the axial dimension of the top and/or bottom bands.

The contact zone between the piston ring and the inner surface of the cylinder may comprise a region bounded by the circumferential contact between a top edge of the piston ring and the inner surface, and a bottom edge of the piston ring and the inner surface.

The contact zone, for example a top contact zone, between the top piston ring and the inner surface of the cylinder may comprise a region bounded by the circumferential contact between a top edge of the top piston ring and the inner surface, and a bottom edge of the top piston ring and the inner surface when the piston is at top dead center of a stroke.

The contact zone, for example a bottom contact zone, between the bottom piston ring and the inner surface of the cylinder may comprise a region bounded by the circumferential contact between a top edge of the bottom piston ring and the inner surface, and a bottom edge of the bottom piston ring and the inner surface when the piston is at top dead center of a stroke.

The top region may be offset, for example by a predetermined distance, from the contact zone between the top piston ring and the inner surface when the piston is at top dead center of a stroke. The top region may be offset from the top contact zone towards the bottom region. The bottom region may be offset, for example by a predetermined distance, from the contact zone between the bottom piston ring and the inner surface when the piston is at bottom dead center of a stroke. The bottom region may be offset from the bottom contact zone towards the top region.

The top region may extend from the top edge of the top piston ring when the piston is at top dead center of a stroke. The top region may extend from the bottom edge of the top piston ring when the piston is at top dead center of a stroke. The top region may extend from in between the top and bottom edges of the top piston ring when the piston is at top dead center of a stroke.

The bottom region may extend from the top edge of the bottom piston ring when the piston is at bottom dead center of a stroke. The bottom region may extend from the bottom edge of the bottom piston ring when the piston is at bottom dead center of a stroke. The bottom region may extend from in between the bottom and top edges of the bottom piston ring when the piston is at bottom dead center of a stroke. The top region and the bottom region may extend towards each other.

According to another aspect of the present disclosure there is provided a method of designing, forming and/or manufacturing a bearing interface of an apparatus, for example a rotary and/or reciprocating machine such as an engine, a compressor, a vacuum pump or a gear box. The apparatus may comprise any type of rotary and/or reciprocating device having the bearing interface. The apparatus comprises a first element and a second element. The first element may be configured to move, for example slide and/or rotate, relative to the second element during operation of the apparatus. The second element may be configured to move, for example slide and/or rotate, relative to the first element during operation of the apparatus. The first element may be fixed, for example stationary, relative to the second element during operation of the apparatus. The second element may be fixed, for example stationary, relative to the first element during operation of the apparatus. The first element comprises a first bearing surface. The second element comprises a second bearing surface. The first and second bearing surfaces are configured to engage each other. The term ‘engage’ is intended to encompass two surfaces which are separated by a thin film of lubricant, as well as surfaces which come into direct physical contact. The first bearing surface is configured to engage at least a portion of a second bearing surface. The portion of the second bearing surface that engages the first bearing surface defines a contact zone between the first bearing surface and the second bearing surface. The first bearing surface has at least one recess, for example a pocket, indented into the first bearing surface. The recess may comprise an opening in the first bearing surface. The method comprises determining the dimension of the contact zone in the direction of movement of the second element. The method comprises designing, forming and/or manufacturing the recess so that the dimension of the recess in the direction of movement of the second element is less than the dimension of the contact zone in the direction of movement of the second element.

According to an aspect of the present disclosure there is provided an engine having one or more cylinders. Each cylinder has an inner surface configured to engage at least a portion of a circumferential surface of a piston ring of an engine piston. The portion of the piston ring that engages the inner surface defines a contact zone between the inner surface of the cylinder and the circumferential surface of the piston ring. The contact zone has a dimension in the direction of travel of the piston, for example an axial dimension that defines the overall length of the contact zone in the direction of travel of the piston. The inner surface has at least one recess indented into the inner surface. The recess has a dimension in the direction of travel of the piston, for example an axial dimension that defines the overall length of the recess in the direction of travel of the piston. The dimension of the recess in the direction of travel of the piston is less than the dimension of the contact zone in the direction of travel of the piston.

According to another aspect of the present disclosure there is provided a method of designing an engine, for example an internal combustion engine. The engine comprises one or more cylinders. Each cylinder has an inner surface configured to engage at least a portion of a circumferential surface of a piston ring of an engine piston. The portion of the piston ring that engages the inner surface defines a contact zone between the inner surface of the cylinder and the circumferential surface of the piston ring. The contact zone has a dimension in the direction of travel of the piston, for example an axial dimension that defines the overall length of the contact zone. The inner surface has at least one recess indented into the inner surface. The method comprises determining the dimension of the contact zone in the direction of travel of the piston. The method comprise designing the recess so that the dimension of the recess in the direction of travel of the piston is less than the dimension of the contact zone in the direction of travel of the piston.

According to another aspect of the present disclosure there is provided an engine having one or more cylinders. Each of the cylinders has an inner surface configured to engage one or more piston rings of an engine piston. The inner surface may comprise a top region having a plurality of recesses indented into the inner surface. The top region may extend towards the bottom end of the cylinder away from a contact zone between a top piston ring and the inner surface when the piston is at top dead center of a stroke. The inner surface may comprise a bottom region having a plurality of recesses indented into the inner surface. The bottom region may extend towards the top end of the cylinder away from a contact zone between a bottom piston ring and the inner surface when the piston is at bottom dead center of the stroke of the piston.

According to another aspect of the present disclosure there is provided a method of manufacturing an engine. The engine comprises one or more cylinders. Each cylinder has an inner surface configured to engage one or more piston rings of an engine piston. The method may comprise providing a plurality of recesses indented into a top region of the inner surface. The top region may extend towards the bottom end of the cylinder away from a contact zone between a top piston ring and the inner surface when the piston is at top dead center of a stroke. The method may comprise providing a plurality of recesses indented into a bottom region of the inner surface. The bottom region may extend towards the top end of the cylinder away from a contact zone between a bottom piston ring and the inner surface at bottom dead center of the stroke of the piston.

To avoid unnecessary duplication of effort and repetition of text in the specification, certain features are described in relation to only one or several aspects or arrangements of the disclosure. However, it is to be understood that, where it is technically possible, features described in relation to any aspect or arrangement of the disclosure may also be used with any other aspect or arrangement of the disclosure.

### BRIEF DESCRIPTION OF THE DRAWINGS

For a better understanding of the present disclosure, and to show more clearly how it may be carried into effect, reference will now be made, by way of example, to the accompanying drawings, in which:

FIG. 1 shows a partial cross section through an engine;

FIG. 2 shows a detailed view of the piston rings of an engine piston;

FIG. 3 shows a diagrammatic representation of a fluid film between a piston ring and an inner surface of a cylinder; and

FIG. 4 shows a cylinder of an engine.

### DETAILED DESCRIPTION

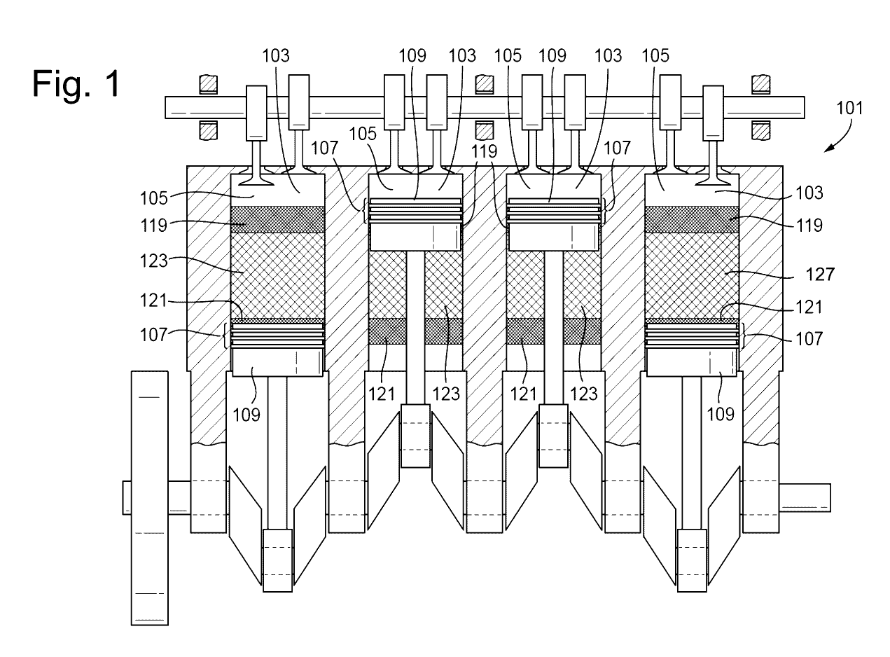

FIG. 1 shows a simplified cross-section of an engine 101. The engine 101 is a four-cylinder engine having an overhead camshaft. However, the engine 101 may be any type of engine, for example a single overhead camshaft (SOHC) engine, a double overhead camshaft (DOHC) engine, an overhead valve (OHV) engine, or other appropriate type of engine. Whilst the engine 101 shown in FIG. 1 is a four-cylinder engine, the engine 101 may comprise any appropriate number of cylinders 103, for example the engine 101 may be a three-cylinder engine, a six-cylinder engine or an eight-cylinder engine. The cylinders 103 may be arranged in an appropriate configuration, such as in-line, horizontally opposed or V-form.

Each of the cylinders 103 comprises an inner surface 105 configured to engage the piston rings 107 of an engine piston 109. The inner surface 105 may be an inner surface of a cylinder bore formed directly into a cylinder block of the engine 101, as shown in FIG. 1. Alternatively, the inner surface 105 may be an inner surface of a cylinder liner that is assembled into the cylinder block.

During operation of the engine 101, each of the pistons 109 reciprocates within the cylinder 103 between a top dead center position and a bottom dead center position. In the context of the present disclosure, the term “top dead center” refers to the furthest point of a piston's travel, at which it changes from an upward stroke, i.e. away from a crankshaft of the engine 101, to a downward stroke, i.e. towards the crankshaft of the engine 101. The term “bottom dead center” refers to the furthest point of a piston's travel, at which it changes from a downward to an upward stroke. In a similar manner, the term “top” end of the cylinder 103 refers to an end of the cylinder 103 at which the piston 109 reaches top dead center, and the term “bottom” end of the cylinder 103 refers to an end of the cylinder 103 at which the piston 109 reaches bottom dead center.

During the operation of the engine 101, the linear speed of the piston 109 varies between a minimum speed, for example a zero speed when the piston is stationary relative to cylinder 103 at top dead center or bottom dead center, and a maximum speed as the piston 109 moves between top center and bottom dead center. As a result of the change in speed of the piston 109, the coefficient of friction between the piston rings 107 and the inner surface 105 of the cylinder varies as the piston 109 travels within the cylinder bore.

In order to reduce the friction between the sliding components of the engine 101, such as the piston rings 107 and the inner surface 105 of the cylinder, a lubricant may be used. The frictional coefficient between sliding components may be determined using the Stribeck curve, which is used to categorize the frictional properties between two surfaces as a function of the viscosity of the lubricant and the relative speed between the components per unit load. Friction may be minimized by operating at the minimum point on the Stribeck curve, which defines the tribological transition between hydrodynamic lubrication and mixed lubrication. However, it is difficult to maintain operation at the minimum point on the Stribeck curve across the full piston stroke as a result of the cyclical acceleration and deceleration of the piston 109. For example, it is difficult to maintain hydrodynamic lubrication towards the top and bottom ends of the piston stroke owing to the low relative speeds between the piston 109 and the cylinder 103. In particular, at the ends of the travel of the piston 109, where the piston speed drops to zero, a lubricant film between the piston rings 107 and the inner surface 105 of the cylinder 103 can collapse as there is no motion to form a hydrodynamic lubricant film. The collapse of the film is dependent on how fast the lubricant can drain away from a contact zone 111 between the piston rings 107 and the inner surface 105 of the cylinder 103.

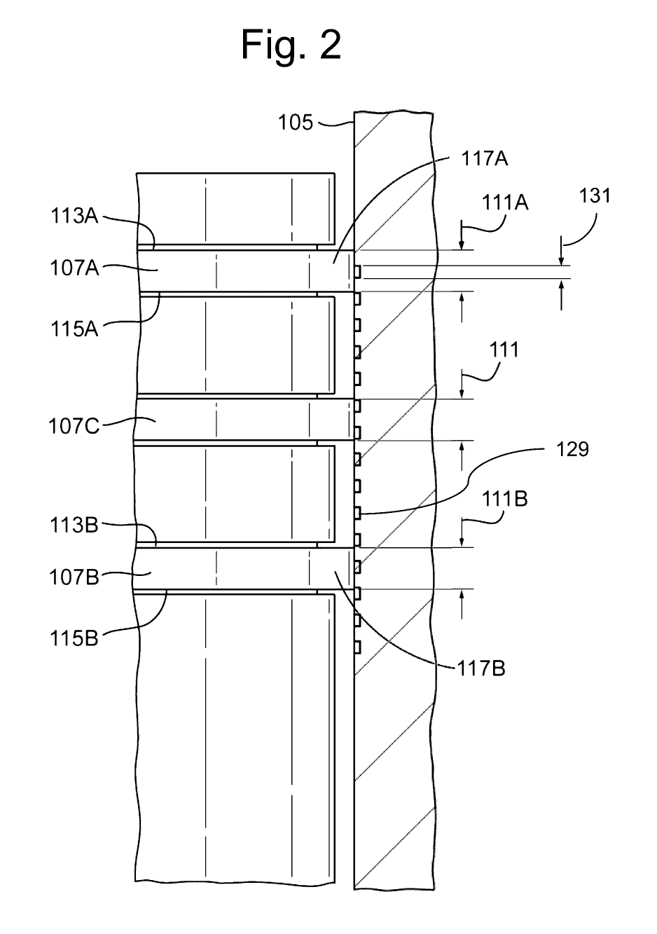

FIG. 2 shows a detailed view of the contact zones 111 between the piston rings 107 and the inner the surface 105 of the cylinder 103. In the arrangement shown in FIGS. 1 to 3, the piston 109 has a top piston ring 107A and a bottom piston ring 107B. However, the piston 109 may have any appropriate number of piston rings 107, for example the piston 109 of FIGS. 1 to 3 has a middle piston ring 107C. Each of the piston rings 107 may be configured to perform a different function, for example top piston ring 107A may be a compression ring configured to provide a seal between the top and bottom of the cylinder 103 on either side of the piston 109, and the bottom piston ring 107B may be and oil scraper ring configured to remove oil from the inner surface 105 of the cylinder 103.

In the arrangement shown in FIG. 2, the top and bottom piston rings 107A, 107B each comprise a circumferential surface 117A, 117B configured to engage the inner surface 105 of the cylinder 103. The piston rings 107 are axially aligned with the piston 109 such that the circumferential surfaces 117A, 117B substantially engage the inner surface 105 of the cylinder 103. In this manner, the contact zone 111A between the top piston ring 107A and the inner surface 105 of the cylinder 103 is defined by a region bounded by the circumferential contacts between a top edge 113A of the top piston ring 107A and the inner surface 105, and a bottom edge 115A of the top piston ring 107A and the inner surface 105. In a similar manner, the contact zone 111B between the bottom piston ring 107B and the inner surface 105 of the cylinder 103 comprises a region bounded by the circumferential contacts between a top edge 113B of the bottom piston ring 107B and the inner surface 105, and a bottom edge 115B of the bottom piston ring 107B and the inner surface 105. However, in a different arrangement, the piston rings 107 may be configured such that only a portion of the or each circumferential surface 117A, 117B engages the inner surface 105 of the cylinder 103. For example the circumferential surfaces 117A, 117B may comprise one or more ribs/projections that extend at least partially around the circumference of the piston rings 107. It is understood therefore that the contact zone 111 between any one of the piston rings 107 may be defined by the portion of the circumferential surface of the piston ring 107 that engages the inner surface 105 of the cylinder 103.

The inner surface 105 of the cylinder 103 comprises a top region 119 located towards the top end of the cylinder 103 and a bottom region 121 located towards the bottom end of the cylinder 103. Each of the top and bottom regions 119, 121 may comprise a plurality of recesses 129 indented into the inner surface 105. The recesses 129 may comprise any type opening in the inner surface 105 that enables a fluid, such as a lubricant, to be held within the opening as the piston ring 107 moves over the opening. For example, the recesses 129 may comprise a plurality of pockets shaped to retain lubricant, and/or decrease the rate at which lubricant drains away from the contact zones 111. The pockets may be of any shape, for example the pockets may be square, rectangular, circular or any other shape. In one arrangement, the pockets may be of a similar shape to each other. In another arrangement, the plurality of pockets may comprise a number of differently formed/shaped pockets, for example the plurality of pockets may comprise a number of round-bottomed pockets and a number of square-bottomed pockets that are configured to trap lubricant.

For the pockets to be effective, lubricant needs to be restricted from “leaking” out of the pocket as the piston ring 107 travels over it. This can be achieved by having a contact zone 111 that is larger than an opening 131 of the recess 129 in the direction of travel of the piston 109. In FIG. 2, each of the piston rings 107 has a circumferential surface that has a straight/flat profile such that the circumferential surface is substantially parallel to the inner surface 105 during operation of the engine. In such an arrangement, the dimension of the contact zone 111 in the direction of travel of the piston 109 may be defined by the dimension between the top and bottom edges of the piston ring 107. In order to prevent the lubricant from leaking out of the pocket, the pocket may be designed such that the overall dimension 131 of the pocket in the direction of travel of the piston 109 is less than the dimension between the top and bottom edge of the piston ring 107.

However, the circumferential surface may have a curved profile, for example a barreled profile. The dimension of the contact zone 111 in the direction of travel of the piston 109 may be defined by the size, e.g. axial length, of an elastic contact zone between the inner surface and a portion of the circumferential surface of the piston ring 107 that deforms elastically under loading. For example, the dimension of the contact zone 111 in the direction of travel of the piston 109 may be defined by a portion of the curved profile that deforms elastically to provide a portion of the circumferential surface that is parallel with the inner surface 105 of the cylinder 103. The size of the elastic contact zone may be dependent upon the radial loading of the piston ring 107 against the inner surface 105, the shape/form of the circumferential surface of the piston ring 107, and/or the material properties, e.g. the Young's modulus, of the respective surfaces. In order to prevent the lubricant from leaking out of the pocket, the pocket may be designed such that the overall dimension 131 of the pocket in the direction of travel of the piston 109 is less than the dimension of the elastic contact zone in the direction of travel of the piston.

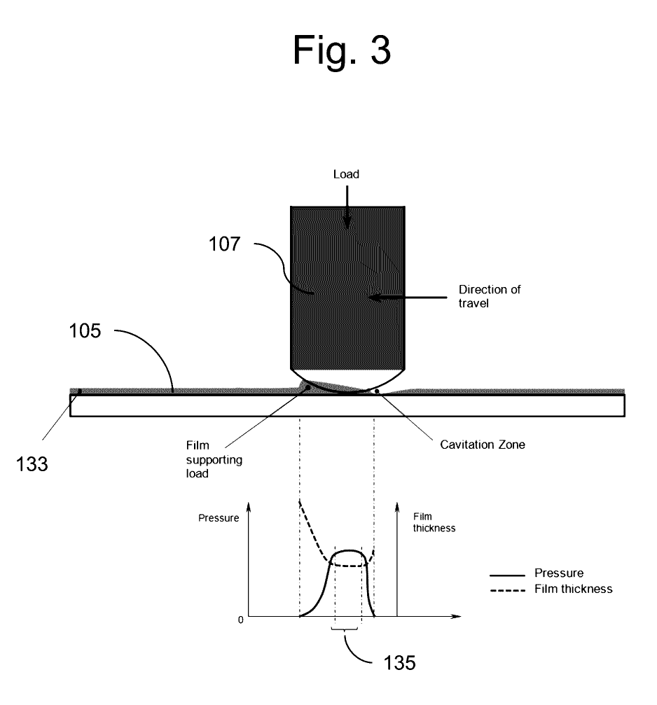

During operation of the engine, a lubricant film 133 may be formed between the circumferential surface of the piston ring 107 and the inner surface 105 of the cylinder 103, for example as a result of the motion between the respective surfaces. The lubricant film 133 may be used to separate the inner surface 105 and the circumferential surface of the piston ring 107 so that there is no physical contact between the two surfaces. FIG. 3 shows a diagrammatic representation of the lubricant film 133 between the piston ring 107 and the inner surface 105 of the cylinder 103 as the piston ring 107 moves relative to the inner surface 105. The lubricant film 133 has a film thickness that is a function of the shape of the circumferential surface of the piston ring 107, the velocity gradient between the piston ring 107 and the inner surface 105, the shear stress in the lubricant, the dynamic viscosity of the lubricant, and/or the radial loading of the piston ring 107. In FIG. 3, the thickness of the lubricant film 133 varies between a maximum thickness in a convergence zone in front of the piston ring 107 and a minimum thickness in a divergence zone behind the piston ring 107, for example where the film 133 cavitates. As a result, the hydrodynamic pressure generated in the lubricant film 133 varies as a function of film thickness. FIG. 3 shows the relationship between film thickness and hydrodynamic pressure.

In FIG. 3, the piston ring 107 is a barreled piston ring having a curved circumferential surface that deforms elastically under loading, which results in a portion of the circumferential surface being parallel with the inner surface 105 of the cylinder 103. As a result, the lubricant film 133 has a portion 135 of constant film thickness in the region where the circumferential surface is parallel with the inner surface 105. In order to prevent the lubricant from leaking out of the pocket, the pocket may be designed such that the overall dimension 131 of the pocket in the direction of travel of the piston 109 is less than the length of the portion 135 of the lubricant film 133 that has a substantially constant film thickness, i.e. the length of the portion 135 of the lubricant film 133 that generates a substantially constant hydrodynamic pressure. In an arrangement where the hydrodynamic pressure acts to separate the circumferential surface of the piston ring 107 from the inner surface 105, the overall dimension of the contact zone 111 may be determined by the dimension of a high pressure region of the lubricant film 133 in the direction of travel of the piston 109. Further, the hydrodynamic pressure may act to deform elastically a portion of the circumferential surface of the piston ring 107. The overall dimension of the elastic contact zone may therefore be a function of the hydrodynamic pressure generated in the lubricant film 133 and the properties of the material from which piston ring is manufactured.

By trapping lubricant, it is possible to ensure that the lubrication regime remains hydrodynamic and prevents contact between the piston rings 107 and the inner surface 105 of the cylinder 103, for example in those regions of the inner surface 105 where the speed of the piston 109 approaches zero. However, in those regions of the inner surface 105 where the speed of the piston 109 high, for example mid stroke of the piston 109, the provision of recesses may act to increase the coefficient of friction as a hydrodynamic film may already be established due to the high relative speeds between the piston rings 107 and surface 105 of the cylinder 103. It is desirable therefore to provide recesses in regions of the inner surface 105 only where the relative speeds between piston rings 107 and the inner surface 105 approach zero, for example where the piston 109 is at top dead center and bottom dead center of the piston stroke.

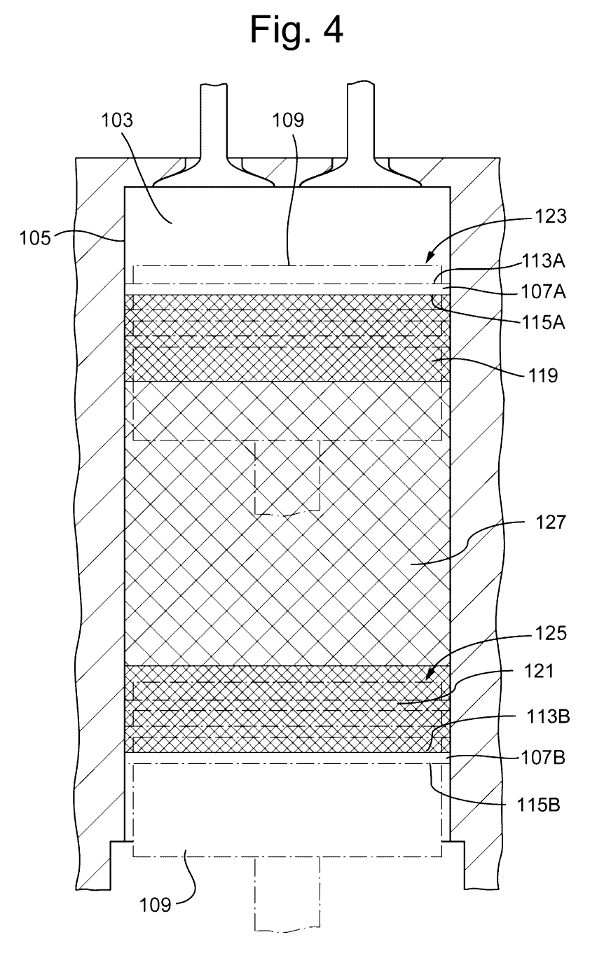

FIG. 4 shows a schematic view of the cylinder 103 having the piston 109 in a first position 123 at top dead center and in a second position 125 at bottom dead center. The top region 119 of the inner surface 105 extends towards the bottom end of the cylinder 103 away from the contact zone 111A between the top piston ring 107A and the inner surface 105 when the piston 109 is at top dead center of a stroke. In the arrangement shown in FIG. 4, the top region 119 extends from the bottom edge 115A of the top piston ring 107A when the piston 109 is at top dead center. However, the top region 119 may extend from any portion of the contact zone 111A between the top piston ring 107A and the inner surface 105 when the piston 109 is at top dead center of a stroke. For example, the top region 119 may extend from the top edge 113A of the top piston ring 107A, or from any point in between the top and bottom edges 113A, 115A when the piston 109 is at top dead center. In another arrangement, the top region 119 may be offset, for example towards the bottom region 121, from the contact zone 111A between the top piston ring 107A and the inner surface 105 when the piston 109 is at top dead center of a stroke. It is appreciated therefore that in each of the above-mentioned arrangements, the top region 119 does not extend beyond the extent of travel of the top piston ring 107A, and that the plurality of recesses are not provided beyond the extent of travel of the top piston ring 107A when the piston 109 is at top dead center of a stroke.

The bottom region 121 extends towards the top end of the cylinder 103 away from the contact zone 111B between the bottom piston ring 107B and the inner surface 105 when the piston 109 is at bottom dead center of a stroke. In the arrangement shown in FIG. 4, the bottom region 121 extends from the top edge 113B of the bottom piston ring 107B when the piston 109 is at bottom dead center. However, the bottom region 121 may extend from any portion of the contact zone 111B between the bottom piston ring 107B and the inner surface 105 when the piston 109 is at bottom dead center of a stroke. For example, the bottom region 121 may extend from the bottom edge 115B of the bottom piston ring 107B, or from any point in between the top and bottom edges 113B, 115B when the piston 109 is at bottom dead center. In another arrangement, the bottom region 121 may be offset, for example towards the top region 119, from the contact zone 111B between the bottom piston ring 107B and the inner surface 105 when the piston 109 is at bottom dead center of a stroke. It is appreciated therefore that in each of the above-mentioned arrangements, the bottom region 121 does not extend beyond the extent of travel of the bottom piston ring 107B, and that the plurality of recesses are not provided beyond the extent of travel of the bottom piston ring 107B when the piston 109 is at bottom dead center of a stroke.

The inner surface 105 of the cylinder 103 may comprise a middle region 127 in between the top and bottom regions 119, 121. The middle region 127 may be proximate to the top and bottom regions 119, 121, or may be spaced apart and separate from the top and bottom regions 119, 121. The middle region 127 may provide a region of the inner surface that has no recesses configured to trap fluid, for example the middle region 127 of the inner surface 105 may be a smooth surface that separates the top and bottom regions 119, 121. The middle region may be provided across the majority of the inner surface 105, with the top and bottom regions being provided towards the top and bottom ends of the inner surface. The inner surface 105 of the cylinder 103 may, therefore, be configured to provide discrete regions 119, 121 that are configured to prevent the lubrication regime from transitioning into boundary lubrication from hydrodynamic lubrication in the regions of the piston stroke where the speed of the piston 109 approaches zero. In this manner, the coefficient of friction is minimized by maintaining a lubrication regime that operates near to the minimum of the Stribeck curve during operation of the engine.

The Figures show example configurations with relative positioning of the various components. If shown directly contacting each other, or directly coupled, then such elements may be referred to as directly contacting or directly coupled, respectively, at least in one example. Elements described as directly downstream or directly upstream of one another may be defined herein such that there are no intervening components between the two comparative elements. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated by those skilled in the art that although the invention has been described by way of example with reference to one or more arrangements, it is not limited to the disclosed arrangements and that alternative arrangements could be constructed without departing from the scope of the invention as defined by the appended claims.

1. A bearing interface of an apparatus, the apparatus having a first element and a second element configured to move relative to each other during operation of the apparatus, the first element comprising a first bearing surface configured to engage at least a portion of a second bearing surface of the second element thereby defining a contact zone between the first bearing surface and the second bearing surface, the first bearing surface having at least one recess indented into the first bearing surface, a dimension of the recess in a direction of movement of the second element relative to the first element being less than a dimension of the contact zone in the direction of movement of the second element.

2. The bearing interface according to claim 1, wherein the first bearing surface and at least the portion of the second bearing surface are parallel in the contact zone during operation of the apparatus, wherein the second bearing surface is configured to deform elastically upon engagement with the first bearing surface, the dimension of the contact zone in the direction of movement of the second element being defined by a dimension of the elastically deformed portion of the second bearing surface in the direction of movement of the second element.

3. The bearing interface according to claim 2, wherein the dimension of the recess in the direction of movement of the second element is less than the dimension of the elastically deformed portion of the second bearing surface in the direction of movement of the second element.

4. The bearing interface according to claim 1, wherein a film of lubricant is provided in the contact zone between the first bearing surface and the second bearing surface during operation of the apparatus, the film of lubricant having a film thickness that is substantially constant in the direction of movement of the second element during operation of the apparatus.

5. The bearing interface according to claim 4, wherein the dimension of the recess in the direction of movement of the second element is less than a dimension of the film of lubricant in the direction of movement of the second element, wherein the recess is configured to trap lubricant and increase locally the thickness of the film of lubricant in the contact zone.

6. A machine comprising a bearing interface, the machine comprising an apparatus having a first element and a second element configured to move relative to each other during operation of the apparatus, the first element comprising a first bearing surface configured to engage at least a portion of a second bearing surface of the second element thereby defining a contact zone between the first bearing surface and the second bearing surface, the first bearing surface having at least one recess indented into the first bearing surface, wherein a dimension of the recess in a direction of movement of the second element relative to the first element is less than a dimension of the contact zone in the direction of movement of the second element.

7. The machine according to claim 6, wherein:
the first element is a piston cylinder and the first bearing surface is an inner surface of the piston cylinder; and
the second element is a piston ring and the second bearing surface is a circumferential surface of the piston ring that is configured to engage the inner surface of the cylinder.

8. The machine according to claim 7, wherein the inner surface comprises at least one of:
a top region having a plurality of the recesses indented into the inner surface, wherein the top region extends towards the bottom end of the cylinder away from a contact zone between a top piston ring and the inner surface when the piston is at top dead center of a stroke; and
a bottom region having a plurality of the recesses indented into the inner surface, wherein the bottom region extends towards the top end of the cylinder away from a contact zone between a bottom piston ring and the inner surface when the piston is at bottom dead center of the stroke of the piston.

9. The machine according to claim 8, wherein the top region and the bottom region are separated by a middle region having no recesses indented into the inner surface, wherein the top region and the bottom region are spaced apart in a direction of travel of the piston.

10. The machine according to claim 8, wherein the top region is offset from the contact zone between the top piston ring and the inner surface when the piston is at top dead center of a stroke, wherein the bottom region is offset from the contact zone between the bottom piston ring and the inner surface when the piston is at bottom dead center of a stroke.

11. The machine according to claim 8, wherein the contact zone between the top piston ring and the inner surface of the cylinder comprises a region bounded by a circumferential contact between a top edge of the top piston ring and the inner surface, and a bottom edge of the top piston ring and the inner surface when the piston is at top dead center of a stroke.

12. The machine according to claim 8, wherein the contact zone between the bottom piston ring and the inner surface of the cylinder comprises a region bounded by a circumferential contact between a top edge of the bottom piston ring and the inner surface, and a bottom edge of the bottom piston ring and the inner surface when the piston is at top dead center of a stroke.

13. The machine according to claim 11, wherein the top region extends from the top edge of the top piston ring when the piston is at top dead center of a stroke.

14. The machine according to claim 11, wherein the top region extends from the bottom edge of the top piston ring when the piston is at top dead center of a stroke.

15. The machine according to claim 11, wherein the top region extends from in between the top and bottom edges of the top piston ring when the piston is at top dead center of a stroke.

16. The machine according to claim 12, wherein the bottom region extends from the top edge of the bottom piston ring when the piston is at bottom dead center of a stroke.

17. The machine according to claim 12, wherein the bottom region extends from the bottom edge of the bottom piston ring when the piston is at bottom dead center of a stroke.

18. The machine according to claim 12, wherein the bottom region extends from in between the bottom and top edges of the bottom piston ring when the piston is at bottom dead center of a stroke.

19. The machine according to claim 8, wherein the top region and the bottom region extend towards each other; wherein the machine is an engine or a compressor, wherein the recesses are provided in a bore of a cylinder block or in a bore of a cylinder liner.

20. An apparatus, comprising:
a bearing interface with a first bearing surface engaging a second bearing surface thereby defining a contact zone therebetween, the first bearing surface having at least one recess indented into the first bearing surface, a dimension of the recess in a direction of movement of the second surface relative to the first surface being less than a dimension of the contact zone in the direction of movement of the second surface.
